(19) United States
(12) Patent Application Publication
(10) Pub. No.: US 2009/0033454 A1
(43) Pub. Date: Feb. 5, 2009

(54) MEMS actuators with even stress distribution

(75) Inventors: Stephane Menard, Kirkland (CA); Nicolas Gonon, Montreal (CA); Jean-Francois Saheb, Verdun (CA)

Correspondence Address: STEPHANE MENARD;C/O SIMPLER NETWORKS INC., 1840 TRANSCANDA, SUITE 100, DORVAL QUEBEC, H9P 1H7, CA

(73) Assignee: SIMPLER NETWORKS INC., Dorval (CA)

(21) Appl. No.: 11/882,457

(22) Filed: Aug. 1, 2007

(51) Int. Cl. H01H 37/00

(52) U.S. Cl. 337/298

(57) ABSTRACT

The micro-electromechanical (MEMS) switch comprises a first double-sided cantilever MEMS actuator attached to a substrate and movable in two opposite directions, and a second cantilever MEMS actuator attached to the substrate. In use, the first MEMS actuator is moved in either directions to distribute the stress more uniformly, thereby reducing the mechanical creep and improving its reliability as well as its operation life.

### TECHNICAL FIELD

The technical field relates to Micro-Electromechanical Systems (MEMS) and in particular to actuators for chip level MEMS devices.

### BACKGROUND

MEMS devices are small movable mechanical structures advantageously constructed using semiconductor processing methods. Oftentimes MEMS devices are provided as actuators and have proven quite useful in a wide variety of applications.

A MEMS actuator is oftentimes configured and disposed in a cantilever fashion. Accordingly, it thus has an end attached to a substrate and an opposite free end suspended above the substrate. The free end is movable between at least two positions, one being a neutral position and the other(s) being deflected positions.

Common actuation mechanisms used in MEMS actuators include electrostatic, magnetic, piezo and thermal, the last of which is the primary focus of the improvement presented hereafter. The deflection of a thermal MEMS actuator results from a potential being applied between a pair of terminals—commonly called “anchor pads” in the art—which potential causes a current flow elevating the temperature of the structure. This in turn causes a part thereof to either elongate or contract, depending upon the particular material(s) used.

A known use of thermal MEMS actuators is to configure them as switches. Such MEMS switches offer numerous advantages over alternatives and in particular, they are extremely small, relatively inexpensive, consume little power and exhibit short response times.

Examples of MEMS actuators and switches can be found in U.S. Pat. No. 7,036,312 issued May 2, 2006 to Stephane MENARD et al., which patent is hereby incorporated by reference.

Given the importance of thermally actuated MEMS devices, new designs enhancing their performance, reliability and/or manufacturability always represent a significant advance in the art.

### SUMMARY

In accordance with one aspect of the improved design, there is provided a method of evenly distributing stresses in a micro-electromechanical (MEMS) switch comprising: a first double-sided cantilever MEMS actuator attached to a substrate and laterally movable in two opposite directions; and a second cantilever MEMS actuator attached to the substrate and adjacent to the first MEMS actuator. The method comprising the steps of moving the first MEMS actuator in a first or a second of the two directions, and moving the second MEMS actuator to set the MEMS switch in either a first or a second latched position, respectively; and moving the first and second MEMS actuators to set the MEMS switch to an unlatched position. In use, the first or the second direction is selected so as to evenly distribute stresses therein and mitigate mechanical creep.

In accordance with another aspect of the improved design, there is provided a micro-electromechanical (MEMS) switch comprising: a first double-sided cantilever MEMS actuator attached to a substrate and movable in two opposite directions; and a second cantilever MEMS actuator attached to the substrate; wherein the first MEMS actuator is operated in either directions to mitigate mechanical creep in the first MEMS actuator.

In accordance with another aspect of the improved design, there is provided a micro-electromechanical (MEMS) switch comprising: a first cantilever MEMS actuator attached to a substrate and comprising a two opposite first hot arm members, a first cold arm member and a first dielectric tether attached to a free end of the two first hot arm members and a free end of the first cold arm member; and a second cantilever MEMS actuator attached to the substrate and comprising a second hot arm member, a second cold arm member and a second dielectric tether attached to a free end of the second hot arm member and a free end of the second cold arm member. The first MEMS actuator is operated in either directions to mitigate creep in the switch.

### BRIEF DESCRIPTION OF THE FIGURE

FIG. 1 is a semi-schematic plan view of a representative example of an improved MEMS switch with one actuator having a double hot arm member.

### DETAILED DESCRIPTION

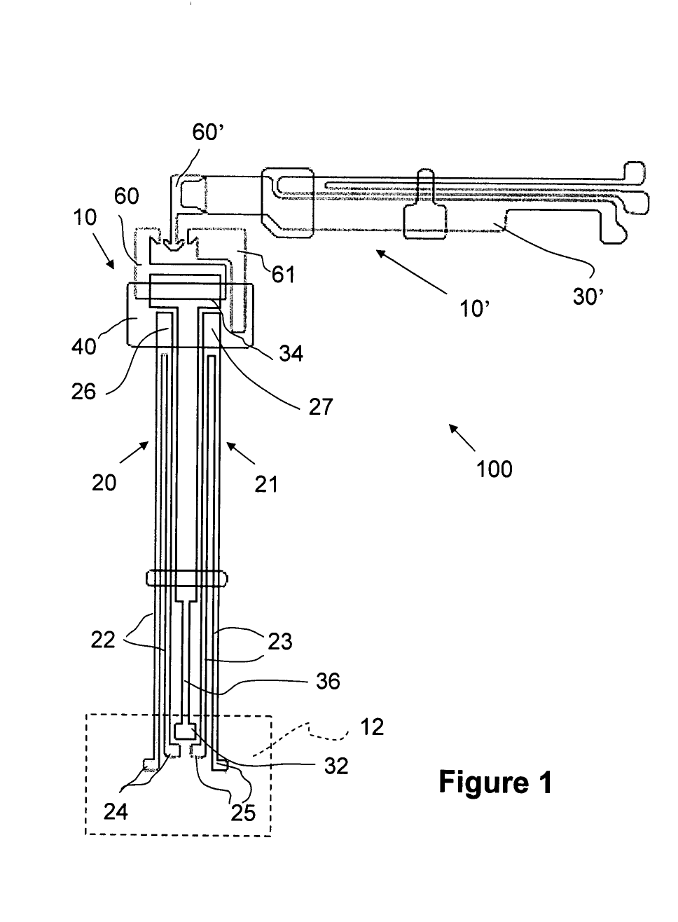

FIG. 1 shows an example of a micro-electromechanical (MEMS) cantilever actuator 10 as improved herein. This actuator 10 comprises two opposite hot arm members 20,21 that are substantially parallelly-disposed on the side of a common cold arm member 30. The hot arm member 20 includes two spaced-apart portions 22, each being provided at one end with a corresponding anchor pad 24 attached to a substrate, which substrate is schematically represented by reference numeral 12. The substrate 12 is oftentimes significantly larger than illustrated. Likewise, the opposite hot arm member 21 includes two spaced-apart portions 23, each being provided at one end with a corresponding anchor pad 25 attached to the substrate 12. The spaced-apart portions 22,23 may be substantially parallel as shown in FIG. 1. They are connected together at a respective common free end 26,27 that is opposite the anchor pads 24,25. The free ends 26,27 is suspended above the substrate 12. The anchor pads 24,25 are offset since one of the portions 22,23 of each hot arm member 20,21 is slightly longer than the other.

The cold arm member 30 has, at one end, an anchor pad 32 connected to the substrate 12, and a free end 34 that is opposite the anchor pad 32 thereof. The free end 34 is suspended above the substrate 12.

In the illustrated example, a dielectric tether 40 is attached to the free end 26,27 of both hot arm members 20,21 and the free end 34 of the cold arm member 30. As can be appreciated, the dielectric tether 40 mechanically couples the hot arm members 20 and the cold arm member 30 while keeping them electrically isolated, thereby maintaining them in a spaced-apart relationship with a minimum spacing between them to avoid a direct contact or a short circuit in normal operation as well as to maintain the required withstand voltage, which voltage is roughly proportional to the spacing between the members 20,21,30.

In the embodiment shown in FIG. 1, the cold arm member 30 comprises a narrower section 36 adjacent to its anchor pad 32 in order to facilitate the movement between the deflected positions and the neutral position. The narrower section 36 is called flexor.

When a control voltage is applied at the anchor pads 24 of the hot arm member 20, an electrical current flows into both the first and the second portions 22 thereby heating the whole member 20. Likewise, when a control voltage is applied at the anchor pads 25 of the hot arm member 21, an electrical current flows into both the first and the second portions 23 thereby heating the whole member 21. In the illustrated example, the material used for making the hot arm member 20,21 is selected such that it increases in length as it is heated. The cold arm member 30, however, does not elongate since there is no current initially flowing through it and therefore, it is not actively heated. As a result of one of the hot arm members 20,21 increasing in length and the cold arm member 30 staying substantially the same length, the free end of the actuator 10 is deflected sideward, thereby moving the actuator 10 from a neutral position to a deflected position. Conversely, when the control voltage is removed, the hot arm member 20,21 cools and shortens in length. As a result, the actuator 10 returns to its neutral position. Both movements may occur very rapidly.

One use for the MEMS actuator 10 is to provide two or more of such actuators 10 to create a switch 100. In FIG. 1, two substantially-perpendicular actuators 10,10′ are used. The second actuator 10′ is a single-sided actuator. It should be noted, however, that the two actuators 10,10′ can be constructed differently than what is shown. In the illustrated example, tip members 60,60′ at the end of the actuators 10,10′ are each connected to an electrical conductor, such as the cold arm members 30,30′, to convey electrical power or a signal when the switch 100 is closed.

In use, by heating the hot arm member 20 or 21, one can make the actuator deflecting to the right or to the left respectively. The free end 34 has two tip members 60,61 that can be latched to the corresponding tip member 60′ of actuator 10′. This configuration advantageously exhibits two electrically latched positions, which can be electrically independent or not. They can be operated in a predetermined sequence, such as one side after the other, or randomly or even a combination of both. This way, the stresses are more evenly distributed and the mechanical creep is mitigated.

It must be understood that the improvements is not limited to the illustrated examples and various changes and modifications may be effected therein without departing from the scope of the appended claims. For instance, the actuators must not necessarily be constructed as shown. Other equivalents can be devised as well using the teachings of the present specification and the appended figure.

What is claimed is:

1. A method of evenly distributing stresses in a micro-electromechanical (MEMS) switch comprising:
a first double-sided cantilever MEMS actuator attached to a substrate and laterally movable in two opposite directions; and
a second cantilever MEMS actuator attached to the substrate and adjacent to the first MEMS actuator;
the method comprising the steps of:
moving the first MEMS actuator in a first or a second of the two directions, and moving the second MEMS actuator to set the MEMS switch in either a first or a second latched position, respectively; and
moving the first and second MEMS actuators to set the MEMS switch to an unlatched position;
wherein, in use, the first or the second direction is selected so as to evenly distribute stresses therein and mitigate mechanical creep.

2. The MEMS actuator of claim 1, wherein the selection of the first and the second direction follows a predetermined sequence.

3. The MEMS actuator of claim 1, wherein the selection of the first and the second direction follows a random sequence.

4. A micro-electromechanical (MEMS) switch comprising:
a first double-sided cantilever MEMS actuator attached to a substrate and movable in two opposite directions; and
a second cantilever MEMS actuator attached to the substrate;
wherein the first MEMS actuator is operated in either directions to mitigate mechanical creep in the first MEMS actuator.

5. The MEMS switch of claim 4, wherein the directions of operation of the first MEMS actuator are following a predetermined sequence.

6. The MEMS switch of claim 4, wherein the directions of operation of the first MEMS actuator are following a random sequence.

7. The MEMS switch of claim 4, wherein the first MEMS actuator has a double-sided tip member, each side of the double-sided tip member being electrically independent.

8. The MEMS switch of claim 4, wherein the first MEMS actuator has a double-sided tip member, each side of the double-sided tip member being electrically dependent.

9. A micro-electromechanical (MEMS) switch comprising:
a first cantilever MEMS actuator attached to a substrate and comprising a two opposite first hot arm members, a first cold arm member and a first dielectric tether attached to a free end of the two first hot arm members and a free end of the first cold arm member; and
a second cantilever MEMS actuator attached to the substrate and comprising a second hot arm member, a second cold arm member and a second dielectric tether attached to a free end of the second hot arm member and a free end of the second cold arm member;
wherein the first MEMS actuator is operated in either directions to mitigate creep in the switch.

10. The MEMS switch of claim 9, wherein the directions of operation of the first MEMS actuator are following a predetermined sequence.

11. The MEMS switch of claim 9, wherein the directions of operation of the first MEMS actuator are following a random sequence.

12. The MEMS switch of claim 9, wherein the first MEMS actuator has a double-sided tip member, each side of the double-sided tip member being electrically independent.

13. The MEMS switch of claim 9, wherein the first MEMS actuator has a double-sided tip member, each side of the double-sided tip member being electrically dependent.
